(19) United States
(12) Patent Application Publication
(10) Pub. No.: US 2018/0160659 A1
(43) Pub. Date: Jun. 14, 2018

(54) REPTILE HIDE SYSTEM AND METHOD

(71) Applicant: Barry Rice, Beltsville, MD (US)

(72) Inventor: Barry Rice, Beltsville, MD (US)

(21) Appl. No.: 15/691,728

(22) Filed: Aug. 30, 2017

Related U.S. Application Data
(60) Provisional application No. 62/432,060, filed on Dec. 9, 2016.

(51) Int. Cl. A01K 63/00; A01K 1/00

(52) U.S. Cl. CPC A01K 63/006; A01K 1/0076; A01K 1/0064

(57) ABSTRACT

A reptile hide assembly including, at least one reptile hide comprising a hollow structure constructed of a translucent heat resistant material having at least one opening to provide access and egress for a small creature, a plurality of removably-coupleable tubular structures and at least one elevating stand configured to provide viewing to an observer of the small creature within the reptile hide. The device may be modularly assembled.

### CROSS REFERENCE TO RELATED APPLICATION

The present application is related to and claims priority to U.S. Provisional Patent Application No. 62/432,060 filed Dec. 9, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of animal husbandry and more specifically relates to a reptile hide system.

### 2. Description of Related Art

Many individuals have pets in modern society. A pet or companion animal is an animal kept primarily for a person's company, protection, and/or entertainment rather than as a working animal, sport animal, livestock, or laboratory animal. Popular pets are often noted for their attractive appearances, and their loyal or playful personalities. The animals that are kept as pets can be from almost any type of animal. Each pet can have its challenges to look after properly. One such type of animal is reptiles. Individuals who own reptiles as pets may have difficulty viewing the reptile due to their natural instinct to hide. A suitable solution is desired.

U.S. Pat. No. 7,222,587 to Dennis Todd Hagel relates to an accessible view-in housing structure for cavity dwelling animals. The described accessible view-in housing structure for cavity dwelling animals includes a housing structure that includes a transparent opening in one wall thereof, the opening being covered with a transparent material such as PLEXIGLAS®. This opening allows a user to view the interior of the structure and ascertain the welfare of any animals within or check for pests without opening the birdhouse and risk frightening or harming the animals. In addition, the housing structure may also include a light within such that a user can illuminate the interior thereof. This allows the user to inspect the interior of the structure when it is too dark to do so without the help of an artificial light source. Moreover, the structure may include a removable roof or side wall for easy access to the interior of the birdhouse for the purpose of cleaning and the like, or access ports that may be used to access the structure without opening.

### BRIEF SUMMARY OF THE INVENTION

In view of the foregoing disadvantages inherent in the known animal husbandry art, the present disclosure provides a novel reptile hide system and method. The general purpose of the present disclosure, which will be described subsequently in greater detail, is to provide an effective reptile hide that provides safety and comfort for the pet and allows for ease of viewing by the pet guardian.

A reptile hide is disclosed herein. The reptile hide includes a reptile hide for providing a hiding place for a small creature in captivity comprising: a hollow structure that may have an external surface, an internal surface, and an internal volume; the hollow structure may comprise a three dimensional shape; at least one opening in the structure is configured to provide access and egress for the small creature (pet reptile or other) to and from the internal volume. The body may be configured to provide viewing to an observer of the small creature within the reptile hide.

A method of using reptile hide is also disclosed herein. The method of using reptile hide may comprise the steps of: providing reptile hide for providing a hiding place for a small creature in captivity comprising: a hollow structure may have an external surface, an internal surface, and an internal volume; the hollow structure may comprise a three dimensional shape; at least one opening in the structure configured to provide access and egress for the small creature to and from the internal volume; and wherein the body may be configured to provide viewing to an observer of the small creature within the reptile hide; placing the reptile hide in a closure; coupling tubular structures; positioning the tubular structures in an enclosure; coupling the tubular structures to stands; and placing food/water dish in the enclosure.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a reptile hide system and method, constructed and operative according to the teachings of the present disclosure.

FIG. 1 is a front perspective view of the reptile hide during an ‘in-use’ condition, according to an embodiment of the disclosure.

FIG. 2 is a front perspective view of the reptile hide of FIG. 1, according to an embodiment of the present disclosure.

FIG. 3 is a front perspective view of the reptile hide of FIG. 1, according to an embodiment of the present disclosure.

FIG. 4 is a front perspective view of the reptile hide assembly, according to an embodiment of the present disclosure.

FIG. 5 is a flow diagram illustrating a method of use for the reptile hide, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to animal husbandry and more particularly to a reptile hide system and method as used to improve the use of the hide disclosed herein.

Generally, the reptile hide may be one or a set of transparent caves and tunnels capable of being used by reptiles. The transparency of each device allows reptile owners to view their pets, even when the reptile maintains its natural hiding habit(s) where it is comfortable. The caves can be available in numerous sizes and designs, each with a small entrance to allow the reptile to rest comfortably within. There can be an open and close vent on the side or the top for additional airflow as desired. The caves and tunnels are intended to maintain high-heat temperatures to ensure a natural environment for the reptile. Reptiles can travel through the caves and tunnels as desired while still allowing the pet owner to view the reptile and keep them safe. This reptile hide can be constructed using hard plastic and other suitable materials. Each material used in construction must be able to withstand temperatures up to 80 and 90-degrees Fahrenheit. The tunnels may measure approximately 4-5″ in length in preferred embodiments and be connected together in order to form an elongated tunnel. Further, each tunnel and cave can be available in various colors.

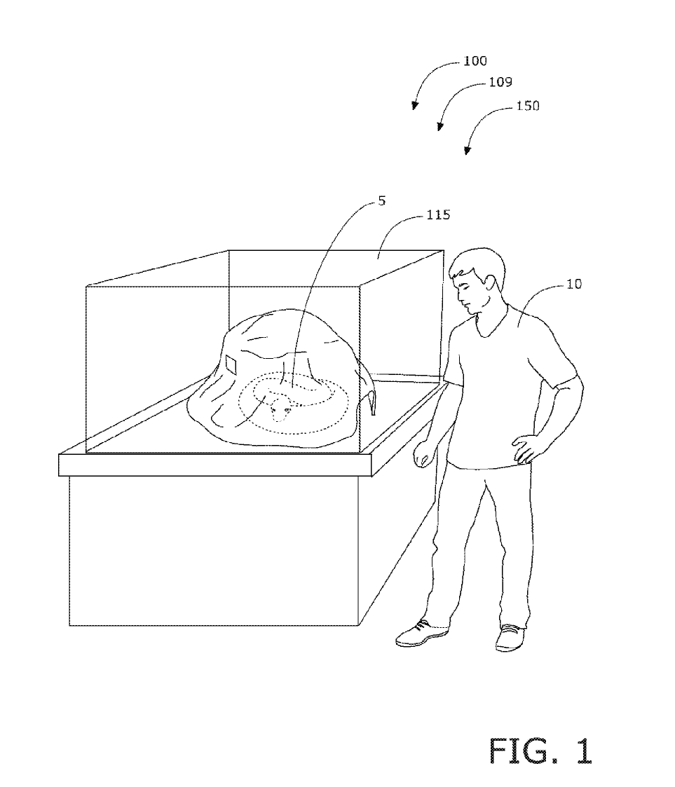

Referring now more specifically to the drawings by numerals of reference, there is shown in FIGS. 1-4, various views of a reptile hide 100. FIG. 1 shows a reptile hide 100 during an ‘in-use’ condition 150, according to an embodiment of the present disclosure. As Illustrated, the reptile hide 100 for providing a hiding place for a small creature 5 in captivity may be defined by a hollow structure 101 that in the preferred embodiment may include an external surface 103, an internal surface 105, and an internal volume 107, to form a hollow structure 101 that may be configured in a three dimensional shape 109 that further may include at least one opening 111 in the structure. As such the structure is configured to provide access and egress for the small creature 5 to and from the internal volume. The body of the hollow structure 101 may be constructed using a translucent material to provide viewing to an observer of the small creature 5 within the reptile hide 100.

Another embodiment of the reptile hide 100 for providing a hiding place for a small creature 5 in captivity comprises a hollow structure 101 having an external surface 103, an internal surface 105, and an internal volume 107; the hollow structure 101 comprising a three dimensional shape 109. At least one opening 111 in the hollow structure 101 is configured to provide access and egress for the small creature 5 to and from the internal volume 107. Like other embodiments the body of the hollow structure 101 may be configured to provide viewing to an observer of the small creature 5 within the reptile hide 100 as such the three dimensional shape 109 is constructed of a translucent material. It should be noted that optionally other semi-transparent, transparent and opaque materials may be used in the construction of the hallow structure 101 as desired.

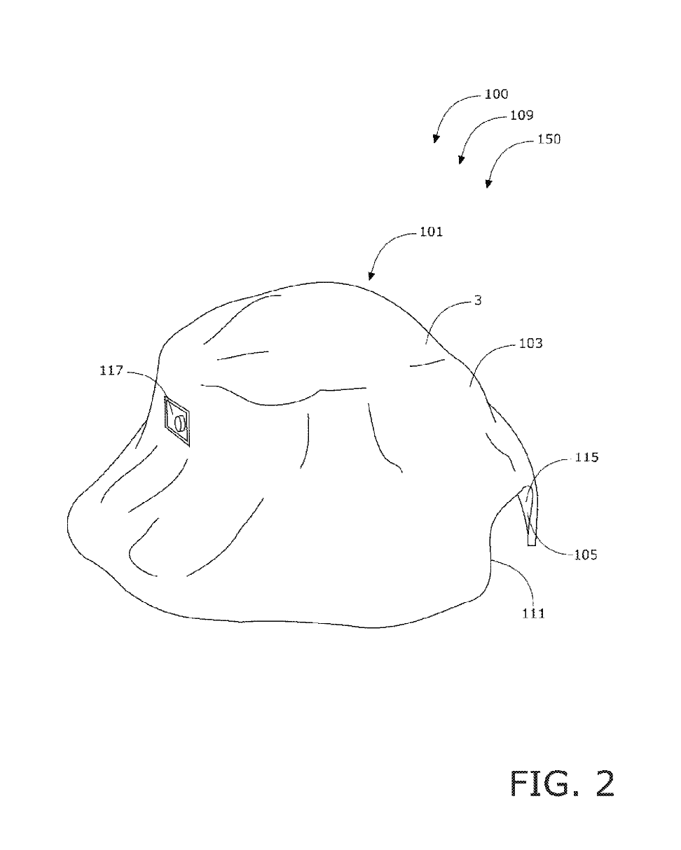

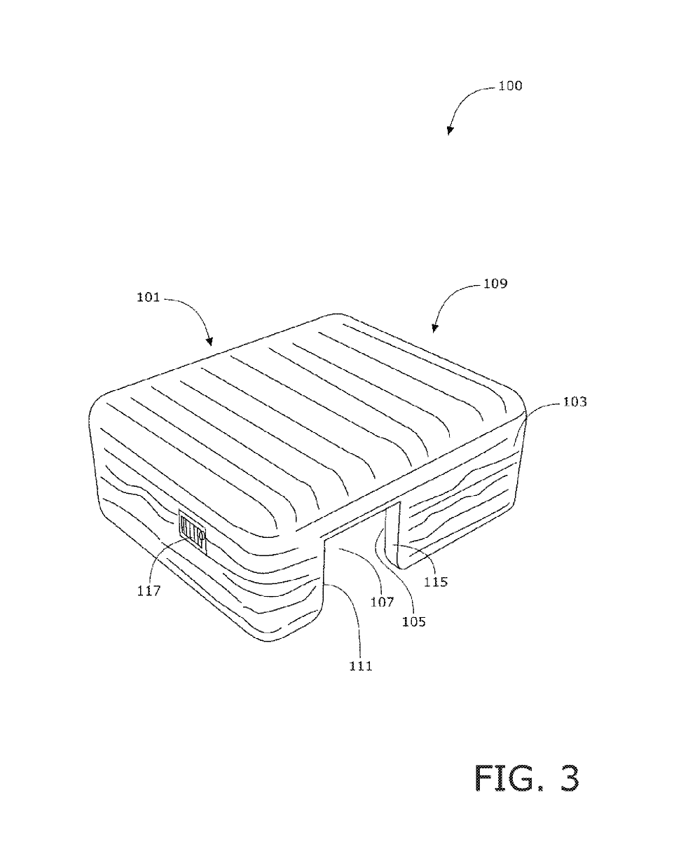

Additionally the three dimensional shape 109 may comprise a shape of/form of a rock/cave as illustrated in FIG. 2. Other embodiments may include a three dimensional shape 109 that may be configured in a shape of a 3D box as shown in FIG. 3. Alternatively a three dimensional shape 109 may include other configurations like a geometagon (other 3D geometric profiles) shapes defined by geometric configurations consisting shapes for example including octagon, hexagon, pentagon and the like.

According to an embodiment of the present disclosure an opening in at least one wall 115 forms a cave like structure and at least one wall 115 may include a vent. The vent 117 may also be adjustable and the translucent material used for constructing the cave like structure may include a thermal conductive material. Other materials that have high heat tolerable may be desirable as well.

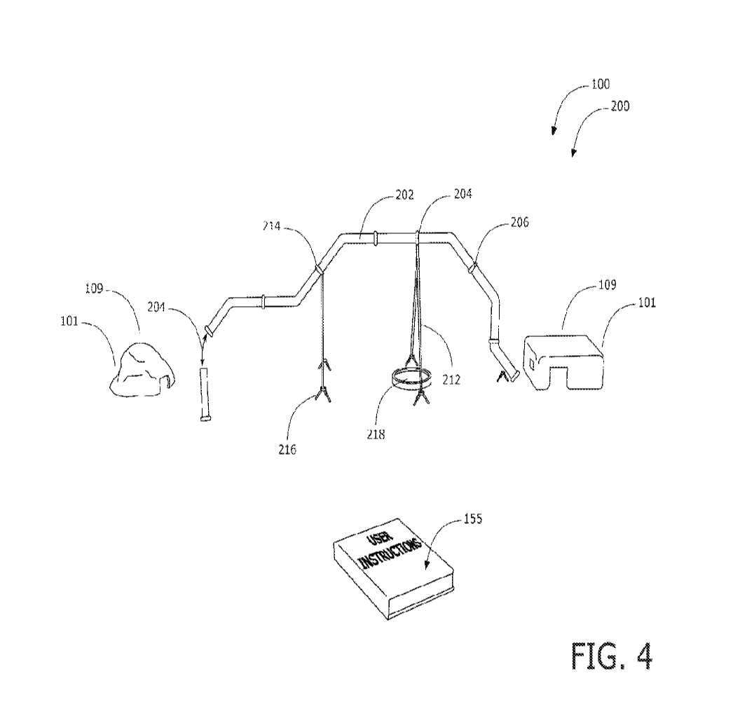

FIG. 4 is a front perspective view of the reptile hide assembly 200, according to an embodiment of the present disclosure. A reptile hide assembly 200 including, at least one reptile hide 100 comprising a hollow structure having an external surface 103, an internal surface 105, an internal volume 107, and at least one opening 111 configured to provide access and egress for a small creature 5. A plurality of tubular structures 202 wherein the at least one tubular structure may be removably-coupleable 204 to a second tubular structure 202 forming a tunnel and at least one reptile hide 100 and the tunnel may be configured to provide an artificial habitat for the small creature 5.

In the preferred embodiment the plurality of tubular structures 202 may be configured to be releasably 204 together via a friction fit 206 or alternatively a threaded engagement lock. The plurality of tubular structures 202 includes at least one straight-tube 208 and at least one bent-tube 210 and the plurality of tubular structures 202 are made of translucent material. Semi-transparent, transparent and opaque material may be used to construct the tubular structures 202 in other embodiments of the present invention. Additionally the plurality of tubular structures 202 may be made of thermal conductive or heat resistant material.

Further the plurality of tubular structures 202 may be releasably coupleable 204 to an elevating stand 212 that may also be adjustable via threaded engagement, a friction-clamp 214 or the like. The elevating stand 212 may further include a tripod base 216. The reptile hide assembly 200 may also include a food/water dish 218.

According to one embodiment, the reptile hide 100 may be arranged as a kit. The kit may include a set of instructions; the instructions may detail functional relationships in relation to the structure of the reptile hide 100 (such that the reptile hide 100 can be used, maintained, or the like, in a preferred manner).

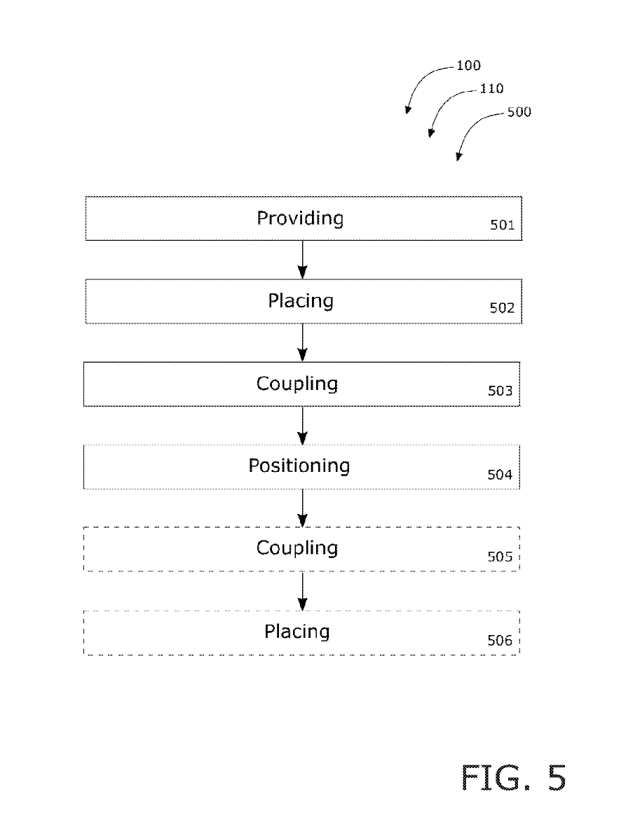

FIG. 5 is a flow diagram 550 illustrating a method of assembling 500 a reptile hide assembly 200, according to an embodiment of the present disclosure. As illustrated, the method 500 of assembling a reptile hide assembly 200 may include the steps of: Step one 501, providing reptile hide for providing a hiding place for a small creature 5 in captivity comprising: a hollow structure 101 which may have an external surface 103, an internal surface 105, and an internal volume 107; the hollow structure 101 may comprise a three dimensional shape; at least one opening 111 in the structure configured to provide access and egress for the small creature 5 to and from the internal volume 107. The body may be configured to provide viewing to an observer of the small creature 5 within the reptile hide 100. Step two 502, includes placing the reptile hide 100 in an enclosure 113; step three 503, coupling tubular structures 202; step four 504, positioning the tubular structures 202 in an enclosure 113. Step five 505, may comprise coupling the tubular structures 202 to a stand 212 and step six 506, placing food/water dish 218 in the enclosure 113.

It should be noted that steps 505 and 506 may be optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use of and maintenance of the reptile hide 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A reptile hide for providing a hiding place for a small creature in captivity comprising:
a hollow structure having an external surface, an internal surface, and an internal volume, said hollow structure comprising a three dimensional shape;
at least one opening in said structure configured to provide access and egress for said small creature to and from said internal volume; and
wherein said body is configured to provide viewing to an observer of said small creature within said reptile hide.

2. The reptile hide of claim 1, wherein said three dimensional shape is constructed of a translucent material.

3. The reptile hide of claim 1, wherein said three dimensional shape comprises a rock/cave.

4. The reptile hide of claim 1, wherein said three dimensional shape is configured in a shape of a 3D box.

5. The reptile hide of claim 1, wherein said three dimensional shape is configured in a geometagon shape.

6. The reptile hide of claim 1, wherein said opening in at least one wall forms a cave like structure.

7. The reptile hide of claim 1, wherein said wall includes a vent.

8. The reptile hide of claim 7, wherein said vent is adjustable.

9. The reptile hide of claim 2, wherein said translucent material is constructed of a thermal conductive material.

10. A reptile hide assembly comprising;
at least one reptile hide comprising a hollow structure having an external surface, an internal surface, an internal volume, and at least one opening configured to provide access and egress for a small creature;
a plurality of tubular structures;
wherein said at least one tubular structure is removably-coupleable to a second tubular structure forming a tunnel; and
wherein said at least one reptile hide and said tunnel is configured to provide an artificial habitat for said small creature.

11. The reptile hide of claim 10, wherein said plurality of tubular structures are configured to be releasably together via a friction fit and alternately engagement lock.

12. The reptile hide of claim 10, wherein said plurality of tubular structures includes at least one straight-tube and at least one bent-tube.

13. The reptile hide of claim 10, wherein said plurality of tubular structures are made of translucent material.

14. The reptile hide of claim 10, wherein said plurality of tubular structures are made of thermal conductive material.

15. The reptile hide of claim 10, wherein said plurality of tubular structures are releasably to an adjustable elevating stand via threaded engagement.

16. The reptile hide of claim 10, wherein said adjustable elevating stand includes a tripod base.

17. The reptile hide of claim 10, wherein said plurality of tubular structures are releasably to an adjustable elevating stand via a friction-clamp.

18. The reptile hide of claim 10, wherein said system includes a food/water dish.

19. The reptile hide system of claim 1, further comprising set of instructions; and
wherein the reptile hide system is arranged as a kit.

20. A method of assembling a reptile hide assembly, the method comprising the steps of:
providing a reptile hide for providing a hiding place for a small creature in captivity comprising:
a hollow structure having an external surface, an internal surface, and an internal volume, said hollow structure comprising a three dimensional shape;
at least one opening in said structure configured to provide access and egress for said small creature to and from said internal volume; and
wherein said body is configured to provide viewing to an observer of said small creature within said reptile hide;
placing said reptile hide in a closure;
coupling tubular structures;
positioning said tubular structures in an enclosure;
coupling said tubular structures to stands; and
placing food/water dish in the enclosure.
